(19) United States
(12) Patent Application Publication
(10) Pub. No.: US 2006/0073314 A1
(43) Pub. Date: Apr. 6, 2006

(54) Metallized polyimide film for substrate and production method thereof

(75) Inventor: Hiroshi Orikabe, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO. INC, Tokyo (JP)

(21) Appl. No.: 11/239,114

(22) Filed: Sep. 30, 2005

(30) Foreign Application Priority Data
Sep. 30, 2004 (JP) 289165/2004

(51) Int. Cl. B32B 3/00

(52) U.S. Cl. 428/209; 428/325

(57) ABSTRACT

Metallized polyimide films for use as a substrate, in which a conductive layer is adhered to a polyimide film at high peel strength, may be prepared in a relatively small number of steps without using a special material by treating an inorganic filler-containing polyimide film with an alkaline permanganate solution, and subjecting the treated surface to electroless copper plating, or successive electroless copper plating and electrolytic copper plating. Preferably, a potassium permanganate solution or a sodium permanganate solution is used as the alkaline permanganate solution.

### CROSS REFERENCES TO RELATED APPLICATIONS

This application claims priority to Japanese Patent Application No. 2004-289165, filed on Sep. 30, 2004, and which is incorporated herein by reference in its entirety.

### BACKGROUND OF THE INVENTION

1. Field of the Invention

The present invention relates to a metallized polyimide film which is useful as a substrate and a production method thereof. More particularly, the present invention relates to a metallized polyimide film, which is particularly useful as a film for tape automated bonding (TAB) or flexible printed circuits (FPC), and to production methods thereof.

2. Discussion of the Background

Having superior heat resistance, size stability, solvent resistance, and electric • mechanical properties, polyimide has been widely used as an insulating material for electronic equipment and the like. For example, CCL (copper clad lamination) comprising a conductive layer formed on a polyimide film has been used for various purposes including flexible printed circuits (FPC) for tape automated bonding (TAB) and the like.

As conventional CCL, a three-layer CCL polyimide film in which a polyimide film and a copper foil are adhered with an adhesive (e.g., epoxy resin and the like) has been generally used. However, it poses problems since the adhesive to be used exerts an adverse influence on the insulation properties, heat resistance, mechanical strength and the like of CCL, and the inherent characteristics of polyimide are impaired.

Therefore, a two-layer CCL manufactured without using an adhesive by a method (casting method) comprising coating a copper foil with a polyimide varnish or polyamic acid varnish, and drying the same to form a film is currently prevailing. In this casting method two layer CCL, for example, a copper foil having a thickness of about 12-35 μM is used. With a copper foil having a thickness of not less than 12 μm, formation of a fine circuit pattern at a pitch of less than 40 μm by subtractive methods becomes difficult. Thus, a method comprising reducing the thickness of a conductive layer of a two-layer CCL produced using a 12 μm-thick copper foil by half etching, and a method comprising use of a copper foil having a thickness of not more than 5 μm have been employed. In the case of half etching, however, the thickness control is not easy, and when a thin copper foil is used, handling thereof is not easy. Therefore, both of these methods pose problems of disadvantages in regard to cost.

To solve such problems, for example, a method comprising directly forming a metal layer to be a base (e.g., cobalt, nickel, chrome) on a polyimide resin film by sputtering, and forming a conductive layer by electroless copper plating and further by electrolytic copper plating to give a two-layer CCL (sputtering method) has been tried. However, the sputtering method is disadvantageous in cost because it requires a special apparatus, and inconveniences such as pinholes and the like easily occur. In addition, the base metal layer is difficult to remove by etching during circuit formation. Furthermore, the sputtering method CCL has problems in heat resistance and its use at high temperature for a long time tends to result in degraded adhesiveness.

On the other hand, a method for forming a conductive layer on a polyimide film by plating has been tried without relying on the sputtering method and, for example, the following methods (1)-(8) have been reported.

(1) JP-A-3-6382 discloses a method comprising treating a polyimide film with an aqueous alkaine solution to form a modified layer having a thickness of 100-1500 Å, forming an electrolessally plated metal layer of not more than 1 μm on the modified layer, diffusing the metal within the thickness range of from not less than 50 Å to the thickness of the entire modified layer by heating, and adjusting the thickness of the conductive layer to a desired range by electroless plating and electrolytic plating to give a conductive layer.

(2) JP-A-6-21157 discloses a method comprising making a polyimide film hydrophilic with an aqueous solution of permanganate salt or hypochlorite, forming a nickel plating layer, cobalt plating layer or nickelXcobalt plating layer having an impurity content of not more than 10 mass % and a thickness of 0.01-0.1 μm by electroless plating, and further forming a conductive layer by electroless copper plating and electrolytic copper plating.

(3) JP-A-8-031881 discloses a method comprising treating a polyimide film with an aqueous solution containing hydrazine and alkali metal hydroxide, adding a catalyst, forming a nickel, cobalt or alloy layer by electroless plating, and heat treating the layer under an inert atmosphere, and forming a conductive layer by electroless copper plating and electrolytic copper plating.

(4) JP-A-2000-289167 discloses a method comprising adding a palladium compound to a polyimide precursor, heat treating the same, and activating the obtained film with dilute sulfuric acid, and forming a conductive layer by electroless copper plating and electrolytic copper plating.

(5) JP-A-2002-208768 discloses a method comprising treating a polyimide film with an aqueous alkaline solution containing a primary amine-containing organic disulfide compound or a primary amine-containing organic thiol compound, washing and drying the film, adding a catalyst, and forming a conductive layer by electroless copper plating and electrolytic copper plating.

(6) JP-A-2002-256443 discloses a method for forming a conductive layer by subjecting a polyimide film to a swelling treatment, a roughening treatment with an alkaline permanganate solution, a neutralization treatment, a debinding treatment, imide ring opening by alkali treatment, a copper ion adsorption by treatment with copper ion solution, a copper precipitation by reduction treatment, electroless copper plating and electrolytic copper plating.

(7) JP-A-2003-013243 discloses a method comprising treating a polyimide film with aqueous alkalihydroxide solution, hydrolyzing an imide bond, removing a low molecular hydrolysis product, adding a catalyst, and applying electroless metal plating (when high peel strength is necessary, electroless copper plating needs to be performed after electroless nickel plating).

(8) JP-A-2003-136632 discloses a method comprising manufacturing a polyimide film from alkoxysilane modified polyimide, treating the film with a palladium catalyst solution, and forming a conductive layer by electroless copper plating and electrolytic copper plating.

As a method for forming a conductive layer (copper plating layer) without relying on a dry process, a method comprising, as in the above-mentioned (1), (3), (5) and (7), treating the surface of polyimide with an alkaline solution, and introducing a carboxyl group by ring opening reaction of imide ring to enhance affinity for a metal has been mainly tried. However, (1) is associated with a problem in that each step is difficult to control and lacks versatility, (3) requires nickel or cobalt plating prior to copper plating, and (7) also requires nickel plating prior to copper plating so as to afford high peel strength of the conductive layer, and nickel plating and cobalt plating cannot be easily removed by an etching step for circuit formation. Furthermore, (3) and (5) lack versatility and are disadvantageous in cost because they require a special alkaline solution.

In the case of the methods ((2), (6)) wherein a polyimide film is treated with an alkaline permanganate solution, the method of (2) requires nickel plating and cobalt plating prior to copper plating, and the method of (6) requires many steps and complicated operation. Thus, all methods lack versatility and are disadvantageous in cost. In general, moreover, since polyimide films tend to be chemically damaged by alkaline solutions, particularly highly active alkaline permanganate solutions have never been actually used in consideration of the difficulty in controlling the surface during treatments.

With regard to the methods ((4), (8)) wherein a conductive layer is formed without treatments with alkaline solution etc., the method of (4) using a polyimide film containing a copper plating catalyst requires use of a considerable amount of an expensive palladium compound, and the method of (8) using alkoxysilane modified polyimide requires use of a special polyimide. Thus, the both methods lack versatility and are disadvantageous in cost.

### SUMMARY OF THE INVENTION

As mentioned above, conventional methods for forming a conductive layer on a polyimide film by copper plating problematically lack versatility and are inevitably costly, because a conductive layer having high peel strength requires many steps, complicated operation, special materials and control of steps.

Therefore, there is a demand for a more convenient and economical method for forming a conductive layer having high peel strength on a polyimide film.

Accordingly, it is one object of the present invention to provide novel methods for forming a conductive layer having high peel strength on a polyimide film.

It is another object of the present invention to provide novel methods for forming a conductive layer having high peel strength on a polyimide film, which are more convenient and economical.

It is another object of the present invention to provide novel methods of producing metallized polyimide films for a substrate, which are capable of economically manufacturing a metallized polyimide film for a substrate, wherein a conductive layer having high peel strength is adhered to the polyimide film, in relatively a small number of steps without using a special material.

It is another object of the present invention to provide metallized polyimide films for a substrate, which comprise a conductive layer having high peel strength at least on one surface of a polyimide film layer, which is superior in heat resistance, and which can afford a substrate superior in insulation properties, heat resistance, and mechanical strength, and methods of producing a metallized polyimide film, which are capable of producing such metallized polyimide film in relatively a small number of steps without using a special material.

These and other objects, which will become apparent during the following detailed description, have been achieved by the inventors' discovery that a roughening treatment of the surface of a film containing a conventional inorganic filler with an alkaline permanganate solution easily forms suitable roughness on the surface of the polyimide film, and a copper plating the surface of the polyimide film subjected to the roughening treatment affords a conductive layer (copper plating layer) having high peel strength. Further studies based on said findings resulted in the completion of the present invention.

Accordingly, the present invention provides the following:

(1) A method of producing a metallized polyimide film for a substrate, which comprises treating an inorganic filler-containing polyimide film with an alkaline permanganate solution, and subjecting the film to electroless copper plating.

(2) The method of (1), wherein the inorganic filler-containing polyimide film is obtained by drying by heating a resin composition varnish comprising a polyamic acid and/or a polyimide and an inorganic filler.

(3) The method of (2), wherein the resin composition varnish is applied onto a support, and the treatment with an alkaline permanganate solution and the electroless copper plating are successively performed.

(4) The method of (3), wherein the support is a copper foil.

(5) The method of (3), wherein the support is a polyimide film.

(6) The method of any of (1)-(5), wherein the inorganic filler-containing polyimide film is subjected to a swelling treatment with an alkaline solution before the treatment with an alkaline permanganate solution.

(7) The method of any of (1)-(6), which further comprises conducting electrolytic copper plating after the electroless copper plating.

(8) The method of any of (1)-(7), wherein a catalyst is provided onto the surface of the inorganic filler-containing polyimide film before the electroless copper plating.

(9) The method of (8), wherein the catalyst is palladium.

(10) The method of any of (1)-(9), wherein the inorganic filler is one or more kinds selected from the group consisting of silica, silicon particles, and calcium carbonate.

(11) The method of any of (1)-(10), wherein the inorganic filler is silica.

(12) The method of any of (1)-(11), wherein the inorganic filler has an average particle size of 0.01-5 μm.

(13) The method of any of (1)-(12), wherein the inorganic filler is contained in the varnish in a proportion of 2-100 parts by weight per 100 parts by weight of polyamic acid and/or polyimide.

(14) The method of any of (1)-(13), wherein the alkaline permanganate solution is a potassium permanganate solution or a sodium permanganate solution.

(15) The method of any of (1)-(6), (8)-(14), wherein the inorganic filler-containing polyimide film has a thickness of 5-125 μm, and the electroless copper plating layer has a thickness of 0.1-3 μm.

(16) The method of any of (7)-(14), wherein the inorganic filler-containing polyimide film has a thickness of 5-125 μm, the electroless copper plating layer has a thickness of 0.1-3 μm, and the total thickness of the electroless copper plating layer and the electrolytic copper plating layer is 3-35 μm.

(17) The method of any of (4), (6)-(16), wherein the copper foil support has a thickness of 3-35 μm.

(18) The method of any of (5)-(16), wherein the polyimide film support has a thickness of 10-125 μm.

(19) The method of any of (1)-(18), wherein an anneal treatment is conducted after the electroless copper plating or the electrolytic copper plating.

(20) The method of any of (1)-(19), wherein the inorganic filler-containing polyimide film further comprises one or more kinds of heat resistant resins selected from the group consisting of polyamide, polyamideimide, polyetheretherketone, polyetherimide, polybenzoxazole and polybenzoimidazole in a proportion of not more than 30 parts by weight relative to 100 parts by weight of polyimide.

(21) The method of (20), wherein the heat resistant resin has a phenolic hydroxyl group in a molecular skeleton.

(22) A metallized polyimide film for a substrate, which comprises a polyimide film layer and a conductive layer formed on at least one surface of the polyimide film layer, wherein the polyimide film layer comprises an inorganic filler and has a roughening treated surface on which the conductive layer is formed.

(23) The metallized polyimide film of (22), wherein the polyimide film layer containing an inorganic filler is formed on a support.

(24) The metallized polyimide film of (23), wherein the support is a copper foil layer.

(25) The metallized polyimide film of (23), wherein the support is a polyimide film layer.

(26) The metallized polyimide film of any of (22)-(25), wherein the inorganic filler is one or more kinds selected from the group consisting of silica, silicon particles and calcium carbonate.

(27) The metallized polyimide film of any of (22)-(25), wherein the inorganic filler is silica.

(28) The metallized polyimide film of any of (22)-(27), wherein the inorganic filler has an average particle size of 0.01-5 μm.

(29) The metallized polyimide film of any of (22)-(28), wherein the polyimide film layer has an inorganic filler content of 2-100 parts by weight relative to 100 parts by weight of polyimide.

(30) The metallized polyimide film of any of (22), (26)-(29), wherein the polyimide film layer has a thickness of 5-125 μm, and the conductive layer has a thickness of 3-35 μm.

(31) The metallized polyimide film of any of (24), (26)-(29), which comprises a laminate of the copper foil layer/the inorganic filler-containing polyimide film layer/the conductive layer laminated in this order, wherein the copper foil layer has a thickness of 3-35 μm, the polyimide film layer has a thickness of 5-125 μm, and the conductive layer has a thickness of 3-35 μm.

(32) The metallized polyimide film of any of (25)-(29), which comprises a laminate of the polyimide film layer/the inorganic filler-containing polyimide film layer/the conductive layer laminated in this order, wherein the polyimide film layer has a thickness of 10-125 μm, the inorganic filler-containing polyimide film layer has a thickness of 5-125 μm, and the conductive layer has a thickness of 3-35 μm.

(33) The metallized polyimide film of any of (22)-(32), wherein the roughening treated surface of the inorganic filler-containing polyimide film layer has a surface roughness of 100-1500 nm.

(34) The metallized polyimide film of any of (22)-(33), wherein the conductive layer is a copper plating layer.

(35) The metallized polyimide film of any of (22)-(34), wherein the roughening treatment of the roughening treated surface of the inorganic filler-containing polyimide film layer is a treatment with an alkaline permanganate solution.

(36) The metallized polyimide film of (35), wherein the alkaline permanganate solution is a potassium permanganate solution or a sodium permanganate solution.

(37) The metallized polyimide film of any of (22)-(36), wherein the inorganic filler-containing polyimide film further comprises one or more kinds of heat resistant resins selected from the group consisting of polyamide, polyamideimide, polyetheretherketone, polyetherimide, polybenzoxazole and polybenzoimidazole in a proportion of not more than 30 parts by weight relative to 100 parts by weight of polyimide.

(38) The metallized polyimide film of (37), wherein the heat resistant resin has a phenolic hydroxyl group in a molecular skeleton.

According to the present method of producing a metallized polyimide film of the present invention, a metallized polyimide film comprising a conductive layer having high peel strength adhered to the polyimide film, which is particularly preferable for a substrate, can be produced in a relatively small number of steps without using a special material. According to the present invention, the production efficiency can be improved and the production costs can be reduced, as compared to conventional production methods of this kind of metallized polyimide films.

Using a metallized polyimide film of the present invention, moreover, a material for a substrate, which is superior in heat resistance and which does not require complicated steps for circuit formation, can be provided, since the film has a conductive layer having high peel strength, which is formed on at least one surface thereof, and is free of an adhesive and a seed layer between the conductive layer and the polyimide film layer. Consequently, manufacture of a substrate superior in insulation property, heat resistance, mechanical strength and the like at a low cost can be enabled using a metallized polyimide film of the present invention.

### DETAILED DESCRIPTION OF THE PREFERRED EMBODIMENTS

The production method of the metallized polyimide film of the present invention is mainly characterized in that a polyimide film comprising an inorganic filler is treated with an alkaline permanganate solution and then subjected to electroless copper plating.

That is, the present invention is predicated on the finding that, by subjecting a polyimide film containing an inorganic filler (hereinafter to be also referred to as an “inorganic filler-containing polyimide film”), which is formed using a resin composition varnish containing polyamic acid and/or polyimide, and an inorganic filler to a treatment with an alkaline permanganate solution, the surface of the polyimide film comes to have a rough surface which is preferable for electroless copper plating, and by subjecting the roughening treated surface of the polyimide film to electroless copper plating, a conductive layer made of a copper plating layer having high peel strength can be formed. Preferably, by conducting electrolytic copper plating after electroless copper plating, a conductive layer made of a copper plating layer having higher peel strength can be formed. Moreover, since the polyimide film contains an inorganic filler, the surface can be easily controlled even when the surface of the polyimide film is treated with an alkaline permanganate solution, which facilitates formation of a rough surface preferable for forming a conductive layer by plating.

In the production method of a metallized polyimide film of the present invention, the use of a special material is not required, and a metallized polyimide film, which comprises a laminate comprising a polyimide film layer, wherein at least one surface is roughening treated, and a conductive layer made of a copper plating layer, which is adhered at high peel strength to the roughening treated surface(s) of the polyimide film layer, can be obtained in a relatively small number of steps. In addition, the thus-obtained metallized polyimide film does not require an adhesive and a seed layer formed by sputtering or plating for the formation of a copper plating layer. Therefore, it can be used as a material for a substrate, which is superior in heat resistance, and which does not require complicated steps for circuit formation. Using the metallized polyimide film, a substrate superior in insulation properties, heat resistance, mechanical strength, and the like can be manufactured at a low cost.

A resin composition varnish containing polyamic acid and/or polyimide and an inorganic filler to be used in the present invention (hereinafter to be also referred to as an “inorganic filler-containing resin composition varnish”) is made of a polyamic acid varnish, polyimide varnish, or a varnish containing polyamic acid and polyimide (hereinafter to be also collectively referred to as “polyamic acid varnish and the like”) used for producing a polyimide film by casting method and the like and an inorganic filler. As the polyamic acid varnish and the like, conventionally-known ones can be used freely as long as they can form films. The metallized polyimide film to be produced in the present invention is mainly used for substrates such as flexible printed circuit (FPC). To afford a flexible printed circuit superior in heat resistance, mechanical strength, and the like, a varnish containing polyamic acid, which is a condensation polymer of aromatic tetracarboxylic acid and aromatic diamine and/or imidation product (i.e., polyimide) of polyamic acid is preferable.

Specific examples of aromatic tetracarboxylic acids capable of forming polyamic acid and the like include:

pyromellitic acid,

1,2,3,4-benzenetetracarboxylic acid,

1,4,5,8-naphthalenetetracarboxylic acid,

2,3,6,7-naphthalenetetracarboxylic acid,

3,3′,4,4′-biphenyltetracarboxylic acid,

2,2′,3,3′-biphenyltetracarboxylic acid,

2,3,3′,4′-biphenyltetracarboxylic acid,

3,3′,4,4′-benzophenonetetracarboxylic acid,

2,3,3′,4′-benzophenonetetracarboxylic acid,

3,3′,4,4′-diphenylethertetracarboxylic acid,

2,3,3′,4′-diphenylethertetracarboxylic acid,

3,3′,4,4′-diphenylsulfonetetracarboxylic acid,

2,3,3′,4′-diphenylsulfonetetracarboxylic acid,

2,2-bis(3,3′,4,4′-tetracarboxyphenyl)tetrafluoropropane,

2,2′-bis(3,4-dicarboxyphenoxyphenyl)sulfone,

2,2-bis(2,3-dicarboxyphenyl)propane,

2,2-bis(3,4-dicarboxyphenyl)propane,

pyridine-2,3,5,6-tetracarboxylic acid and amide forming derivatives of these. For the production of polyamic acid etc., acid anhydrides of these aromatic tetracarboxylic acids are preferably used, wherein one or more kinds of the compounds are used.

Specific examples of aromatic diamines capable of forming polyamic acid and the like include:

4,4′-diaminodiphenylether,

3,4′-diaminodiphenylether,

4,4′-diaminophenylmethane,

3,3′-dimethyl-4,4′-diaminodiphenylmethane,

4,4′-diaminodiphenylsulfone,

4,4′-di(m-aminophenoxy)diphenylsulfone,

4,4′-diaminodiphenylsulfide,

1,4-diaminobenzene,

2,5-diaminotoluene,

isophoronediamine,

4-(2-aminophenoxy)-1,3-diaminobenzene,

4-(4-aminophenoxy)-1,3-diaminobenzene,

2-amino-4-(4-aminophenyl)thiazole,

2-amino-4-phenyl-5-(4-aminophenyl)thiazole,

benzidine,

3,3′,5,5′-tetramethylbenzidine,

octafluorobenzidine,

o-tolidine,

m-tolidine,

p-phenylenediamine,

m-phenylenediamine,

1,2-bis(anilino)ethane,

2,2-bis(p-aminophenyl)propane,

2,2-bis(p-aminophenyl)hexafluoropropane,

2,6-diaminonaphthalene,

diaminobenzotrifiuoride,

1,4-bis(p-aminophenoxy)benzene,

4,4′-bis(p-aminophenoxy)biphenyl,

diaminoanthraquinone,

1,3-bis(anilino)hexafluoropropane,

1,4-bis(anilino)octafluoropropane,

2,2-bis[4-(p-aminophenoxy)phenyl]hexafluoropropane, and amide forming derivatives thereof, wherein one or more kinds of the compounds are used.

For formation of polyamic acid and the like, aliphatic or alicyclic tetracarboxylic acids such as cyclopentanetetracarboxylic acid, butane-1,2,3,4-tetracarboxylic acid, 2,3,5-tricarboxycyclopentyl acetic anhydride, and the like may be used in place of a part of the aromatic tetracarboxylic acids. In this case, however, the amount of the aliphatic or alicyclic tetracarboxylic acids to be used is preferably not more than 50 mol % relative to aromatic tetracarboxylic acids.

As preferable aromatic tetracarboxylic acids in the present invention, for example, pyromellitic dianhydride, 3,3′,4,4′-biphenyltetracarboxylic acid dianhydride, 3,3′,4,4′-benzophenonetetracarboxylic acid dianhydride, and the like can be mentioned. As preferable aromatic diamines in the present invention, for example, 4,4′-diaminodiphenylether, p-phenylenediamine, 5(6)-amino-1-(4′-aminophenyl)-1,3-trimethylindane, and the like can be mentioned. As polyamic acid and/or polyimide preferable for the present invention, for example, condensation polymers of one or more kinds selected from the above-mentioned preferable aromatic tetracarboxylic acids and the above-mentioned preferable aromatic diamines can be mentioned.

As the organic solvent for use in the varnish, for example, sulfoxide solvents such as dimethyl sulfoxide, diethyl sulfoxide, and the like; formamide solvents such as N,N-dimethylformamide, N,N-diethylformamide, and the like; acetamide solvents such as N,N-dimethylacetamide, N,N-diethylacetamide, and the like; pyrrolidone solvents such as N-methyl-2-pyrrolidone, N-vinyl-2-pyrrolidone, and the like; phenol solvents such as phenol, o-, m- or p-cresol, xylenol, halogenated phenol, catechol, and the like, and nonprotic polar solvents such as hexamethylphosphoramide, γ-butyrolactone, and the like can be mentioned. These are preferably used alone or in a mixture. Furthermore, aromatic hydrocarbon solvents such as xylene and toluene can be also used.

For a polyamic acid varnish and the like, for example, a polyimide varnish or a varnish containing polyamic acid and polyimide can be prepared by heating a tetracarboxylic acid and diamine in the above-mentioned organic solvent for polycondensation to synthesize polyamic acid, whereby a polyamic acid varnish is obtained, and heating the thus-obtained polyamic acid varnish or adding an acetic anhydride/pyridine mixture and the like to the polyamic acid varnish to allow imidation of polyamic acid. In addition, a polyimide varnish can be also produced by a method comprising reacting tetracarboxylic acid anhydride and a diisocyanate compound.

As the aromatic tetracarboxylic acid anhydride for forming a polyimide varnish by this method, acid anhydrides of acids such as

pyromellitic acid,

1,2,3,4-benzenetetracarboxylic acid,

1,4,5,8-naphthalenetetracarboxylic acid,

2,3,6,7-naphthalenetetracarboxylic acid,

3,3′,4,4′-biphenyltetracarboxylic acid,

2,2′,3,3′-biphenyltetracarboxylic acid,

2,3,3′,4′-biphenyltetracarboxylic acid,

3,3′,4,4′-benzophenonetetracarboxylic acid,

2,3,3′,4′-benzophenonetetracarboxylic acid,

3,3′,4,4′-diphenylethertetracarboxylic acid,

2,3,3′,4′-diphenylethertetracarboxylic acid,

3,3′,4,4′-diphenylsulfonetetracarboxylic acid,

2,3,3′,4′-diphenylsulfonetetracarboxylic acid,

2,2-bis(3,3′,4,4′-tetracarboxyphenyl)tetrafluoropropane,

2,2′-bis(3,4-dicarboxyphenoxyphenyl)sulfone,

2,2-bis(2,3-dicarboxyphenyl)propane,

2,2-bis(3,4-dicarboxyphenyl)propane,

pyridine-2,3,5,6-tetracarboxylic acid, and the like can be preferably used, wherein one or more kinds of the compounds are used. It is possible to use acid anhydrides of aliphatic or alicyclic tetracarboxylic acids, such as cyclopentanetetracarboxylic acid, butane-1,2,3,4-tetracarboxylic acid, 2,3,5-tricarboxycyclopentyl acetic anhydride and the like, in place of a part of the aromatic tetracarboxylic acid anhydride. In this case, however, the amount of aliphatic or alicyclic tetracarboxylic acids to be used is preferably not more than 50 mol % relative to aromatic tetracarboxylic acids.

Of the above-mentioned anhydrides,

pyromellitic dianhydride,

3,3′,4,4′-biphenyltetracarboxylic acid dianhydride,

3,3′,4,4′-benzophenonetetracarboxylic acid dianhydride, and the like are particularly preferable.

As the diisocyanate compound, for example, alicyclic diisocyanates such as 1,4-cyclohexanediisocyanate, 1,3-cyclohexanediisocyanate, isophoronediisocyanate, dicyclohexylmethane-4,4′-diisocyanate, and the like; aromatic diisocyanates such as m-phenylenediisocyanate, p-phenylenediisocyanate, diphenylmethane-4,4′-diisocyanate, diphenylether-4,4′-diisocyanate, diphenylsulfone-4,4′-diisocyanate, (1,1′-biphenyl)-4,4′-diisocyanate, (1,1′-biphenyl)-3,3′-dimethyl-4,4′-diisocyanate, 2,4-tolylenediisocyanate, 2,6-tolylenediisocyanate, xylenediisocyanate, 1,4-naphthalenediisocyanate, 1,5-naphthalenediisocyanate, 2,6-naphthalenediisocyanate, 2,7-naphthalenedidsocyanate, and the like; and the like can be mentioned, with preference given to aromatic diisocyanate. These may be used alone or two or more of them may be used in combination.

To obtain a varnish, the polyimide needs to be dissolved in a solvent. In addition, the dicarboxylic acid anhydride and diisocyanate compound may be appropriately selected depending on the solvent to be used and solvent-soluble polyimide can be prepared. As described below, moreover, a commercially available product can be also used.

Two or more kinds of the polyamic acid or polyimide may be used in a mixture.

In the present invention, commercially available products can be used as they are for the polyamic acid varnish and the like. Specific examples of polyamic acid varnish include “Uimide JM-A,” “Uimide JM-C” (both manufactured by UNITIKA LTD.), “KAYAFLEX KPI-100” (manufactured by Nippon Kayaku Co., Ltd.), and the like. Specific examples of polyimide varnish include “Rikacoat SN-20” (manufactured by New Japan Chemical Co., Ltd.) and the like, and further, a varnish obtained by dissolving solvent-soluble polyimide such as “Matrimide 5218” (manufactured by Vantico AG) and the like in an organic solvent can be also mentioned.

The resin composition varnish may contain a slight amount of a heat resistant resin other than polyamic acid and/or polyimide, and as other heat resistant resins, for example, polyamide, polyamideimide, polyetheretherketone, polyetherimide, polybenzoxazole, polybenzoimidazole, and the like can be mentioned, with preference given to polyamide. Two or more heat resistant resins may be mixed and used. The presence of a suitable amount of other heat resistant resin produces a phase separation structure, and when a polyimide film is roughening treated, small roughness are easily formed. For preparation of a resin composition varnish containing a heat resistance resin, a heat resistant resin may be dissolved as it is in a polyamic acid varnish etc., or the heat resistant resin is dissolved in the above-mentioned organic solvent to give a solution, the solution (varnish) is mixed with a polyamic acid varnish etc. and then an inorganic filler is mixed/dispersed therein. To improve affinity for a metal layer or a polyimide film to be a support, a heat resistant resin preferably has a phenolic hydroxyl group in the molecular skeleton, and one having a phenolic hydroxyl group equivalent amount in the range of 100-1500 g/eq is particularly preferable. While the amount of the heat resistant resin to be added varies depending on the kind of the heat resistant resin, it is generally not more than 30 parts by weight, preferably 0.5-30 parts by weight, more preferably 5-30 parts by weight, relative to 100 parts by weight of polyamic acid and/or polyimide. When it exceeds 30 parts by weight, the phase separation tends to be too great.

In the present invention, a resin composition varnish containing polyamic acid and/or polyimide and an inorganic filler can be prepared by mixing • dispersing an inorganic filler with/m the above-mentioned polyamic acid varnish and the like. It can be also prepared by dissolving a commercially available solvent-soluble polyimide in the aforementioned organic solvent to give a solution and mixing • dispersing an inorganic filler with/in the solution. The mixing•dispersion for the preparation of the inorganic filler-containing resin composition varnish can be conducted using a homogenizer, a rotating • revolving mixer, 3-roll mill, ball mill, and the like, with preference given to a homogenizer and a rotating revolving mixer. When a roll mill such as a 3-roll mill and the like is used, the resin composition varnish tends to absorb moisture, and when the moisture absorption is remarkable, the resin is often precipitated on the roll when a solvent-soluble polyimide varnish is used, and the molecular weight may decrease when polyamic acid is used. When the above-mentioned heat resistant resin is added, which can be added optionally, one free of precipitation and decrease in the molecular weight, which are caused by moisture absorption, and the like is selected. Using a roll mill, an inorganic filler is dispersed in advance in the heat resistant resin, and the resin is mixed with polyamic acid varnish and/or polyimide varnish, whereby mixing • dispersion can be conducted well. In addition, an inorganic filler may be dispersed in advance in the aforementioned solvent to give a slurry, and the above-mentioned polycondensation reaction may be conducted in this slurry to give a polyamic acid varnish and/or a polyimide varnish. It is also possible to mix the slurry with polyamic acid varnish and/or polyimide varnish to prepare a resin composition varnish.

In the present invention, as the inorganic filler, those generally used as fillers (e.g., various plastic formed parts, etc) can be used and, for example, silica, alumina, barium sulfate, talc, clay, mica powder, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, barium zirconate, calcium zirconate, silicon particles, and the like can be mentioned. Of these, silica, silicon particles, and calcium carbonate are preferable for achieving superior plating peel strength and the like, and silica is particularly preferable. These inorganic fillers may be surface treated with a surface treatment agent (e.g., silane coupling agent, etc.) for the purpose of improving the moisture resistance of a metallized polyimide film (substrate) to be produced. The inorganic filler may be used alone or two or more kinds thereof may be used in a mixture.

The inorganic filler to be used in the present invention preferably has an average particle size of 0.01-5 μm, more preferably 0.05-2 μm. When the average particle size exceeds 5 μm, a fine pattern may not be formed stably when forming a circuit pattern from a conductive layer formed by plating after a roughening treatment. When the average particle size is less than 0.01 μm, the roughened surface may not be sufficiently formed by a roughening treatment, which may unpreferably result in a failure to provide sufficient plating peel strength. The inorganic filler preferably has a maximum particle size of not more than 10 μm, more preferably not more than 5 μm, and further preferably not more than 3 μm. For controlling the maximum particle size of an inorganic filler, air classification comprising blowing air to an inorganic filler and classifying the inorganic filler based on mass differences, filtration classification comprising dispersing an inorganic filler in water and classifying the inorganic filler by filtration and the like can be mentioned. The amount of the inorganic filler to be added is preferably 2-100 parts by weight, more preferably 5-45 parts by weight, relative to 100 parts by weight of polyamic acid and/or polyimide (solid content, (when a heat resistant polymer is contained, relative to the total amount of polyamic acid and/or polyimide, and heat resistance polymer) in the varnish). When it exceeds 100 parts by weight, degradation of the resin surface becomes remarkable during a roughening treatment and sufficient plating peel strength tends to be difficult to achieve. When it is less than 2 parts by weight, a roughened surface is not sufficiently formed by a roughening treatment and sufficient plating peel strength tends to be difficult to achieve.

The above-mentioned average particle size of the inorganic filler can be measured by laser diffraction • scattering methods based on Mie scattering. To be specific, the particle size distribution of an inorganic filler is plotted based on volume by a laser diffraction type particle size distribution measurement device, and the median diameter can be taken as the average particle size. As a measurement sample, an inorganic filler can be dispersed in water by ultrasonication and preferably used as the sample. As the laser diffraction type particle size distribution measurement device, LA-500 manufactured by HORIBA Ltd. and the like can be used.

The resin composition varnish in the present invention, which contains polyamic acid and/or polyimide, and an inorganic filler, may contain components other than those mentioned above, as long as properties that a polyimide film is required to have for use as a flexible printed circuit, and the effect of the present invention are not impaired. For example, coupling agents, coloring agents, thixotropic agents, antistatic agents, plasticizers and the like can be mentioned. In general, thermosetting resins such as epoxy resin and the like often fail to have heat resistance necessary for polyimide film production, and tend to increase dimensional changes of polyimide film. Thus, it is preferable that thermosetting resins be substantially absent from the polyimide film varnish to be used in the present invention.

In the present invention, an inorganic filler-containing polyimide film is generally formed by applying, on a support, the above-mentioned resin composition varnish containing polyamic acid and/or polyimide, and an inorganic filler, and drying the film by heating. While the thickness of the inorganic filler-containing polyimide film thus produced varies depending on the lamination structure of the object substrate, specific use and the like, it is generally about 5-125 μm. When it is less than 5 μm, the mechanical strength of an insulating layer of the substrate may become insufficient, and when it exceeds 125 μm, the cost becomes high and coating and drying of the varnish tends to be difficult. Then, the inorganic filler-containing polyimide film thus formed is treated with an alkaline permanganate solution and copper plating is applied to the roughened surface treated by the alkaline permanganate solution. As the above-mentioned support, any can be used as long as it is made from a material substantially free from causing property and morphology changes during preparation of an inorganic filler-containing polyimide film by coating with a resin composition varnish containing the above-mentioned polyamic acid and/or polyimide and an inorganic filler, and drying the film by heating. When the final product (metallized polyimide film) is a structure comprising an inorganic filler-containing polyimide film layer laminated on a support, heat resistant films such as polyimide film, aramid film, and the like (preferably polyimide film); metal foils such as copper foil, aluminum foil, stainless foil, and the like (preferably copper foil); and the like are generally used as the support. In the present invention, therefore, whether the support is to be delaminated in advance from an inorganic filler-containing polyimide film before a treatment with an alkaline permanganate solution (when the metallized polyimide film to be produced is a laminate structure without a support) or to be laminated on an inorganic filler-containing polyimide film (when the metallized polyimide film to be produced is a laminate structure having a support) is determined depending on the lamination structure of the produced metallized polyimide film. When a copper foil is used as a support, the thickness of the copper foil is preferably about 3-35 μm, more preferably about 12-35 μm. When the thickness is less than 3 μm, the workability during coating and drying of varnish and the like is degraded, and when the thickness exceeds 35 μm, formation of a fine circuit pattern from the copper foil tends to become difficult. In other words, when a copper foil is used as a conductive layer in the final product (metallized polyimide film for a substrate), a fine circuit pattern cannot be formed easily from the conductive layer. When a polyimide film is used as a support, the thickness of the polyimide film is preferably about 10-125 μm, more preferably about 25-75 μm. When the thickness is less than 10 μm, the supportability during coating and drying of varnish becomes inferior, and when it exceeds 125 μm, the bending property of the final product (metallized polyimide film) is degraded. The polyimide film is used as an insulating layer in the final product (metallized polyimide film for a substrate).

The lamination structure of the metallized polyimide film of the present invention (final product) is as mentioned below.

The drying by heating of an inorganic filler-containing resin composition varnish is divided into an initial heating step for volatilization of solvent to form a film, and middle—last heating steps for complete removal of the solvent. When polyamic acid is used, it is imidated in the middle—last heating step. For example, the initial heating step can be appropriately determined according to the workability while considering difference in the boiling points of solvents, adhesiveness between the support and the resin composition and the like. Generally, it can be appropriately selected from the range of about 1 minute-30 minutes at 75-150° C. In addition, preferable conditions of the middle—last heating steps can be appropriately determined by those of ordinary skill in the art and selected from the range of, for example, 160-370° C. for 1-40 hours. The middle—last heating steps may be one-step heating comprising heating at a constant temperature for a given time. For example, multi-step heating such as three-step heating comprising heating within a low temperature range (constant temperature selected from the range of 160-220° C.) for about 5 minutes-12 hours and then within a middle temperature range (constant temperature selected from the range of 220-300° C.) for about 30-18 hours and then further within a high temperature range (constant temperature selected from the range of 300-370° C.) for about 1-24 hours, and the like is preferably conducted for the purpose of preventing warping of an inorganic filler-containing polyimide film, and the like.

In the present invention, as the alkaline permanganate solution to be used for a roughening treatment of the surface of an inorganic filler-containing polyimide film, for example, a solution obtained by dissolving potassium permanganate or sodium permanganate in an aqueous sodium hydroxide solution can be mentioned. The treatment method using an alkaline permanganate solution is not particularly limited and may be performed by, for example, immersing an inorganic filler-containing polyimide film delaminated from a support in an alkaline permanganate solution heated to 40-80° C., immersing an inorganic filler-containing polyimide film formed on a support in an alkaline permanganate solution heated to 40-80° C., together with the support and the like. While the treatment time is not particularly limited, about 5-20 minutes is preferable. The concentration of the permanganate salt in an alkaline permanganate solution is preferably about 80-150 g/l, more preferably about 110-120 g/l.

It is preferable to conduct a treatment to swell the polyimide film prior to the treatment with the alkaline permanganate solution. For the swelling treatment, an alkaline solution, a surfactant solution and the like can be used, with preference given to an alkaline solution. As the alkaline solution, for example, sodium hydroxide solution, potassium hydroxide solution, and the like can be mentioned. In addition, a commercially available swelling solution may be used and, for example, that produced by Atotech Japan, Swelling Dip Securiganth P and Swelling Dip Securiganth SBU and the like can be mentioned. The method of the swelling treatment is not particularly limited and may be performed by, for example, immersing an inorganic filler-containing polyimide film delaminated from a support in a swelling solution heated to 40-80° C., immersing an inorganic filler-containing polyimide film formed on a support in a swelling solution heated to 40-80° C., together with the support and the like. While the treatment time is not particularly limited, about 5-20 minutes is preferable.

The level of roughness (surface roughness) of the surface of the polyimide film which has been roughened in this way is defined by the arithmetic average roughness (Ra) described in the Japan Industrial Standard (JIS) B0601. Specifically, for example, it can be measured using a surface shape measurement system WYCO NT3300 manufactured by Veeco Instruments. The surface roughness (arithmetic average roughness (Ra)) is preferably 100-1500 nm, more preferably 100-1200 nm, and further preferably 200-800 nm. When it is less than 100 nm, sufficient plating peel strength tends to be unachievable, and when it exceeds 1500 nm, formation of a fine circuit pattern tends to become unpreferably difficult.

A copper plating layer on the surface of the roughness-treated inorganic filler-containing polyimide film, or formation of a conductive layer by copper plating, can be performed by a method combining electroless copper plating and electrolytic copper plating, or a method comprising forming a plating resist of a pattern reverse to the pattern of the conductive layer and forming the conductive layer by electroless copper plating alone.

The electroless copper plating can be conducted according to the methods generally used for additive method or semiadditive method of printed wiring board. That is, a catalyst is provided to the surface of an inorganic filler-containing polyimide film which has been roughening treated by the aforementioned treatment with an alkaline permanganate solution, and immersed in a given electroless copper plating solution under given conditions. As the catalyst to be provided on the roughness-treated surface, palladium metals widely used for electroless copper plating are preferable. While various electroless copper plating solutions having different plating components (e.g., chelating agents, reducing agents, etc.) are commercially available, the solution is not particularly limited.

Plating of the surface of an electroless copper plating by electrolytic copper can be conducted according to a known method. As the electrolytic copper plating solution, various solutions having different plating components can be used. Particularly, a generally used sulfuric acid copper plating bath is preferable.

The thickness of the electroless copper plating layer is generally 0.1-3 μm, preferably 0.3-2 μm. The thickness of the electrolytic copper plating layer is such thickness that makes the total thickness with the electroless copper plating layer to be 3 -35 μm, preferably 5-20 μm. To be specific, an electroless copper plating layer having a thickness of 0.1-3 μm (preferably 0.3-2 μm) is formed, and an electrolytic copper plating layer is formed such that the total thickness of the electroless copper plating layer and the electrolytic copper plating layer becomes 3-35 μm (preferably 5-20 μm).

The thus-obtained conductive layer made of a copper plating layer is formed with high peel strength on the roughening treated surface of an inorganic filler-containing polyimide film. After electroless copper plating, or after successively conducting electroless copper plating and electrolytic copper plating, an annealing treatment is applied at 150-200° C. for about 30 minutes-100 hours, whereby the peel strength of the conductive layer from the inorganic filler-containing polyimide film can be further improved and stabilized.

With such annealing treatment, the peel strength of the conductive layer made of a copper plating layer from the inorganic filler-containing polyimide film of the metallized polyimide film of the present invention can be, for example, not less than 0.6 kgf/cm, preferably not less than 0.7 kgf/cm, as measured by the following measurement method. Measurement method of peel strength.

The measurement was performed according to JIS C6481. The thickness of the conductive plating of the measurement sample was about 30 μm.

The metallized polyimide film of the present invention is used for substrates, and finally manufactured into, for example, the following laminates (1)-(5).

(1) conductive layer (copper plating layer)/inorganic filler-containing polyimide film layer

(2) copper foil layer (support)/inorganic filler-containing polyimide film layer/conductive layer (copper plating layer)

(3) conductive layer (copper plating layer)/inorganic filler-containing polyimide film layer/conductive layer (copper plating layer)

(4) polyimide film layer (support)/inorganic filler-containing polyimide film layer/conductive layer (copper plating layer)

(5) conductive layer (copper plating layer)/inorganic filler-containing polyimide film layer/polyimide film layer (support)/inorganic filler-containing polyimide film layer/conductive layer (copper plating layer)

The laminate (1) is manufactured by producing, on a support, an inorganic filler-containing polyimide film, successively applying an alkaline permanganate solution treatment and an electroless copper plating treatment to form an electroless copper plating layer and then delaminating the support from the inorganic filler-containing polyimide film; or forming an electroless copper plating layer, further forming an electrolytic copper plating layer and then delaminating the support from the inorganic filler-containing polyimide film.

When the laminate (1) is particularly used for a flexible printed circuit (FPC), the thickness of the inorganic filler-containing polyimide film layer is preferably about 10 -75 μm.

The laminate (2) is manufactured by forming an inorganic filler-containing polyimide film on a copper foil, and successively applying an alkaline permanganate solution treatment and an electroless copper plating treatment to form an electroless copper plating layer; or forming an electroless copper plating layer, and further forming an electrolytic copper plating layer.

When the laminate (2) is particularly used for a flexible printed circuit (FPC), the thickness of the inorganic filler-containing polyimide film layer is preferably about 10 -75 μm, particularly preferably about 10-50 μm.

The laminate (3) is manufactured by forming an inorganic filler-containing polyimide film on a support, delaminating the support and successively applying an alkaline permanganate solution treatment and an electroless copper plating treatment to both surfaces of the inorganic filler-containing polyimide film to form electroless copper plating layers; or forming an electroless copper plating layer, and further forming an electrolytic copper plating layer.

When the laminate (3) is particularly used for a flexible printed circuit (FPC), the thickness of the inorganic filler-containing polyimide film layer is preferably about 10-75 μm.

The laminate (4) is manufactured by forming an inorganic filler-containing polyimide film on one surface of a polyimide film (support), and successively applying an alkaline permanganate solution treatment and an electroless copper plating treatment to the inorganic filler-containing polyimide film to form electroless copper plating layers; or forming an electroless copper plating layer, and further forming an electrolytic copper plating layer.

When the laminate (4) is particularly used for a flexible printed circuit (FPC), the thickness of the polyimide film (support) is preferably about 10-75 μm, and the thickness of the inorganic filler-containing polyimide film layer is preferably about 10-75 μm, particularly preferably about 10-25 μm.

The laminate (5) is manufactured by forming an inorganic filler-containing polyimide film on each of the both surfaces of a polyimide film (support), and successively applying an alkaline permanganate solution treatment and an electroless copper plating treatment to both surfaces of the inorganic filler-containing polyimide film to form electroless copper plating layers; or forming electroless copper plating layers, and further forming electrolytic copper plating layers.

When the laminate (5) is particularly used for a flexible printed circuit (FPC), the thickness of the polyimide film (support) is preferably about 10-50 μm, and the thickness of the inorganic filler-containing polyimide film layer is particularly preferably about 10-25 μm.

When a substrate is to be manufactured using a metallized polyimide film of the present invention, a circuit can be formed from a conductive layer (copper plating layer) by subtractive methods and semiadditive methods known to the skilled artisan in the technical field of substrates, and the like. In the case of subtractive methods, an electrolytic plating layer is formed on an electroless copper plating layer, an etching resist is formed thereon and the copper plating layers are etched with an etching solution of ferric chloride, copper (II) chloride, etc. to form a conductor pattern, after which the etching resist is removed to give a circuit. In the case of semiadditive methods, a pattern resist is applied on an electroless copper plating layer, an electrolytic copper plating layer (pattern plating layer) having a desired thickness is formed, the pattern resist is removed and the electroless copper plating layer is removed by flash etching to give a substrate.

A circuit can be formed from a copper foil by, for example, forming an etching resist on the copper foil, and etching the copper foil with an etching solution of ferric chloride, copper (III) chloride, etc. to give a conductor pattern, and removing the etching resist.

Other features of the invention will become apparent in the course of the following descriptions of exemplary embodiments which are given for illustration of the invention and are not intended to be limiting thereof.

### EXAMPLES

In the following examples, “parts” means “parts by mass.”

### Example 1

Polyamic acid varnish “Uimide JM-A” (70 parts, solid content 14.5 w %, manufactured by UNITIKA LTD.) was mixed with silica particles (2.5 parts, average particle size: 0.22 μm), and the mixture was dispersed in a rotating • revolving mixer (AwatoriRentaro AR250, manufactured by Thinky corporation) for 12 minutes to give a resin composition varnish (a).

Then, this resin composition varnish (a) was applied to a mat surface of a 18 μm-thick copper foil with a bar coater such that the resin thickness after drying became 30 μm, and stepwisely dried at 75-130° C. (average 110° C.) for about 20 minutes, at 180° C. for 30 minutes, at 260° C. for 1 hour, and at 350° C. for 2 hour.

The resin composition layer/copper foil composite film thus obtained was first immersed in a swelling solution containing “Swelling Dip Securiganth P” (manufactured by Atotech Japan) at 60° C. for 5 minutes, then in an alkaline permanganate solution at 80° C. for 20 minutes to conduct a roughening treatment of the surface of the resin composition layer, and manganese finally remaining on the surface was removed by reduction (surface roughness: 610 nm).

Subsequently, a catalyst for electroless copper plating was provided to the surface of the resin composition layer after the aforementioned roughening treatment, and the film was immersed in an electroless plating solution at 32° C. for 30 minutes to form a 1.5 μm-thick electroless copper plating film. This was dried at 150° C. for 30 minutes, washed with an acid, and subjected to electrolytic copper plating with a phosphorus-containing copper plate as an anode at anodic current density 2.0 A/dm² for 12 minutes to form a 5 μm-thick copper plating film. After annealing at 180° C. for 30 minutes, the adhesion strength (plating peel strength) between this plating film and a resin composition layer was measured and found to be 0.66 kgf/cm. The film was further subjected to an annealing treatment at 150° C. for 100 hours, and the adhesion strength (plating peel strength) between the plated film and the resin composition layer was measured and found to be 0.68 kgf/cm.

### Example 2

Polyamic acid varnish “Uimide JM-C” (70 parts, solid content 14.5 w %, manufactured by UNITIKA LTD.) was mixed with silica particles (2.5 parts, average particle size: 0.22 μm), and the mixture was dispersed in a rotating • revolving mixer (AwatoriRentaro AR250, manufactured by Thinky corporation) for 12 minutes to give a resin composition varnish (b).

Then, this resin composition varnish (b) was applied to a mat surface of a 18 μm-thick copper foil with a bar coater such that the resin thickness after drying became 30 μm, and stepwisely dried at 75-130° C. (average 110° C.) for about 20 minutes, at 180° C. for 30 minutes, at 260° C. for 1 hour and at 350° C. for 2 hours.

The resin composition layer/copper foil composite film thus obtained was first immersed in a swelling solution containing “Swelling Dip Securiganth P” (manufactured by Atotech Japan) at 60° C. for 5 minutes, then in an alkaline permanganate solution at 80° C. for 20 minutes to conduct a roughening treatment of the surface of the resin composition layer, and manganese finally remaining on the surface was removed by reduction (surface roughness: 678 nm).

Subsequently, a catalyst for electroless copper plating was provided to the surface of the resin composition layer after the aforementioned roughening treatment, and the film was immersed in an electroless plating solution at 32° C. for 30 minutes to form a 1.5 μm-thick electroless copper plating film. This was dried at 150° C. for 30 minutes, washed with an acid, and subjected to electrolytic copper plating with a phosphorus-containing copper plate as an anode at anodic current density 2.0 A/dm² for 12 minutes to form a 5 μm-thick copper plating film. After annealing at 180° C. for 30 minutes, the adhesion strength (plating peel strength) between this plating film and a resin composition layer was measured and found to be 0.91 kgf/cm. The film was further subjected to an annealing treatment at 150° C. for 100 hours, and the adhesion strength (plating peel strength) between the plated film and the resin composition layer was measured and found to be 1.02 kgf/cm.

### Example 3

Polyamic acid varnish “KPI-100” (67 parts, solid content 15.0 w %, Nippon Kayaku Co., Ltd. manufactured by) was mixed with silica particles (2.5 parts, average particle size: 1.1 μm), and the mixture was dispersed in a rotating • revolving mixer (AwatoriRentaro AR250, manufactured by Thinky corporation) for 12 minutes to give a resin composition varnish (c).

Then, this resin composition varnish (c) was applied to a mat surface of a 18 μm-thick copper foil with a bar coater such that the resin thickness after drying became 30 μm, and stepwisely dried at 75-130° C. (average 110° C.) for about 20 minutes, at 180° C. for 30 minutes, at 260° C. for 1 hour and at 350° C. for 2 hours.

The resin composition layer/copper foil composite film thus obtained was first immersed in a swelling solution containing “Swelling Dip Securiganth P” (manufactured by Atotech Japan) at 60° C. for 5 minutes, then in an alkaline permanganate solution at 80° C. for 20 minutes to conduct a roughening treatment of the surface of the resin composition layer, and manganese finally remaining on the surface was removed by reduction (surface roughness: 1110 nm).

Subsequently, a catalyst for electroless copper plating was provided to the surface of the resin composition layer after the aforementioned roughening treatment, and the film was immersed in an electroless plating solution at 32° C. for 30 minutes to form a 1.5 μm-thick electroless copper plating film. This was dried at 150° C. for 30 minutes, washed with an acid, and subjected to electrolytic copper plating with a phosphorus-containing copper plate as an anode at anodic current density 2.0 A/dm² for 12 minutes to form a 5 μm-thick copper plating film. After annealing at 180° C. for 30 minutes, the adhesion strength (plating peel strength) between this plating film and the resin composition layer was measured and found to be 0.98 kgf/cm. The film was further subjected to an annealing treatment at 150° C. for 100 hours, and the adhesion strength (plating peel strength) between the plated film and the resin composition layer was measured and found to be 1.04 kgf/cm.

### Example 4

Soluble polyimide “Matrimide 5218” (manufactured by Vantico AG) was dissolved in N-methyl-2-pyrrolidone to give a 25 w % solution. A phenolic OH group-containing polyamide resin “CPAM702” (phenolic hydroxyl group equivalent amount 677 g/eq, manufactured by Nippon Kayaku Co., Ltd.) was dissolved in N-methyl-2-pyrrolidone to give a 40 w % solution. The 25 w % solution (32 parts) of Matrimide 5218 and the CPAM702 solution (5 parts) were mixed, and silica particles (2.5 parts, average particle size: 1.1 μm), and the mixture was dispersed in a rotating • revolving mixer (AwatoriRentaro AR250, manufactured by Thinky corporation) for 12 minutes to give a resin composition varnish (d).

Then, this resin composition varnish (d) was applied to a mat surface of a 18 μm-thick copper foil with a bar coater such that the resin thickness after drying became 30 μm, and stepwisely dried at 75-130° C. (average 110° C.) for about 20 minutes, at 180° C. for 30 minutes, at 240° C. for 20 hours and at 260° C. for 5 hours.

The resin composition layer/copper foil composite film thus obtained was first immersed in a swelling solution containing “Swelling Dip Securiganth P” (manufactured by Atotech Japan) at 60° C. for 5 minutes, then in an alkaline permanganate solution at 80° C. for 20 minutes to conduct a roughening treatment of the surface of the resin composition layer, and manganese finally remaining on the surface was removed by reduction (surface roughness: 1170 nm).

Subsequently, a catalyst for electroless copper plating was provided to the surface of the resin composition layer after the aforementioned roughening treatment, and the film was immersed in an electroless plating solution at 32° C. for 30 minutes to form a 1.5 μm-thick electroless copper plating film. This was dried at 150° C. for 30 minutes, washed with an acid, and subjected to electrolytic copper plating with a phosphorus-containing copper plate as an anode at anodic current density 2.0 A/dm² for 12 minutes to form a 5 μm-thick copper plating film. After annealing at 180° C. for 30 minutes, the adhesion strength (plating peel strength) between this plating film and the resin composition layer was measured and found to be 0.67 kgf/cm. The film was further subjected to an annealing treatment at 150° C. for 100 hours, and the adhesion strength (plating peel strength) between the plated film and the resin composition layer was measured and found to be 0.8 kgf/cm.

The results of Examples 1-4 are shown in the following Table 1.

TABLE 1

| | | Ex. 1 | Ex. 2 | Ex. 3 | Ex. 4 |
|---|---|---|---|---|---|
| | | Varnish | Varnish | Varnish | Varnish |
| Kind of resin | Product name | (a) | (b) | (c) | (d) |
| Polyamic acid | U imide JM-A | 100 | | | |
| | U imide JM-C | | 100 | | |
| | KPI-100 | | | 100 | |
| Soluble | SN20 | | | | |
| polyimide | Matrimide 5218 | | | | 80 |
| Phenolic OH- | CPAM702 | | | | 20 |
| containing | | | | | |
| polyamide | | | | | |
| Silica | | 25 | 25 | 25 | 25 |
| Surface | | 610 | 678 | 1110 | 1170 |
| roughness (nm) | | | | | |
| of resin | | | | | |
| composition | | | | | |
| layer | | | | | |
| Plating peel | Initial | 0.66 | 0.91 | 0.98 | 0.67 |
| strength | 150° C. | 0.68 | 1.02 | 1.04 | 0.8 |
| (kgf/cm) | after 100 hrs | | | | |

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method of producing a metallized polyimide film, which comprises:
(a) treating an inorganic filler-containing polyimide film with an alkaline permanganate solution, to obtain a treated film; and
(b) subjecting said treated film to electroless copper plating, to form an electroless copper plating layer.

2. The method of claim 1, wherein said inorganic filler-containing polyimide film is obtained by drying by heating a resin composition varnish comprising a polyamic acid and/or a polyimide and an inorganic filler.

3. The method of claim 2, wherein said resin composition varnish is applied onto a support, and said treating with an alkaline permanganate solution and said electroless copper plating are successively performed.

4. The method of claim 3, wherein said support is a copper foil.

5. The method of claim 3, wherein said support is a polyimide film.

6. The method of claim 1, wherein said inorganic filler-containing polyimide film is subjected to a swelling treatment with an alkaline solution before said treating with an alkaline permanganate solution.

7. The method of claim 1, which further comprises:
(c) conducting electrolytic copper plating after said electroless copper plating, to form an electrolytic copper plating layer.

8. The method of claim 1, wherein a catalyst is provided onto the surface of said inorganic filler-containing polyimide film before said electroless copper plating.

9. The method of claim 8, wherein said catalyst is palladium.

10. The method of claim 1, wherein said inorganic filler is one or more kinds selected from the group consisting of silica, silicon particles, calcium carbonate, and mixtures thereof.

11. The method of claim 1, wherein said inorganic filler comprises silica.

12. The method of claim 1, wherein said inorganic filler has an average particle size of 0.01 to 5 μm.

13. The method of claim 2, wherein said varnish comprises said inorganic filler in a proportion of 2 to 100 parts by weight per 100 parts by weight of said polyamic acid and/or polyimide.

14. The method of claim 1, wherein said alkaline permanganate solution comprises at least one member selected from the group consisting of potassium permanganate, sodium permanganate, and mixtures thereof.

15. The method of claim 1, wherein said inorganic filler-containing polyimide film has a thickness of 5 to 125 μm, and said electroless copper plating layer has a thickness of 0.1 to 3 μm.

16. The method of claim 7, wherein said inorganic filler-containing polyimide film has a thickness of 5 to 125 μm, said electroless copper plating layer has a thickness of 0.1 to 3 μm, and the total thickness of said electroless copper plating layer and said electrolytic copper plating layer is 3 to 35 μm.

17. The method of claim 4, wherein said copper foil support has a thickness of 3 to 35 μm.

18. The method of claim 5, wherein said polyimide film support has a thickness of 10 to 125 μm.

19. The method of claim 1, wherein an annealing treatment is conducted after said electroless copper plating.

20. The method of claim 7, wherein an annealing treatment is conducted after said electrolytic copper plating.

21. The method of claim 1, wherein said inorganic filler-containing polyimide film further comprises one or more kinds of heat resistant resins selected from the group consisting of polyamide, polyamideimide, polyetheretherketone, polyetherimide, polybenzoxazole, polybenzoimidazole, and mixtures thereof in a proportion of not more than 30 parts by weight relative to 100 parts by weight of polyimide.

22. The method of claim 20, wherein said heat resistant resin has a phenolic hydroxyl group in a molecular skeleton.

23. A metallized polyimide film, which comprises a polyimide film layer and a conductive layer formed on at least one surface of said polyimide film layer, wherein said polyimide film layer comprises an inorganic filler and has a roughening treated surface on which said conductive layer is formed.

24. The metallized polyimide film of claim 23, wherein said polyimide film layer containing an inorganic filler is formed on a support.

25. The metallized polyimide film of claim 24, wherein said support is a copper foil layer.

26. The metallized polyimide film of claim 24, wherein said support is a polyimide film layer.

27. The metallized polyimide film of claim 23, wherein said inorganic filler is one or more kinds selected from the group consisting of silica, silicon particles, calcium carbonate, and mixtures thereof.

28. The metallized polyimide film of claim 23, wherein said inorganic filler comprises silica.

29. The metallized polyimide film of claim 23, wherein said inorganic filler has an average particle size of 0.01 to 5 μm.

30. The metallized polyimide film of claim 23, wherein said polyimide film layer comprises said inorganic filler in an amount of 2 to 100 parts by weight relative to 100 parts by weight of polyimide.

31. The metallized polyimide film of claim 23, wherein said polyimide film layer has a thickness of 5 to 125 μm, and said conductive layer has a thickness of 3 to 35 μm.

32. The metallized polyimide film of claim 25, which comprises a laminate of said copper foil layer/said inorganic filler-containing polyimide film layer/said conductive layer laminated in this order, wherein said copper foil layer has a thickness of 3 to 35 μm, said polyimide film layer has a thickness of 5 to 125 μm, and said conductive layer has a thickness of 3 to 35 μm.

33. The metallized polyimide film of claim 26, which comprises a laminate of said polyimide film layer/said inorganic filler-containing polyimide film layer/said conductive layer laminated in this order, wherein said polyimide film layer has a thickness of 10 to 125 μm, said inorganic filler-containing polyimide film layer has a thickness of 5 to 125 μm, and said conductive layer has a thickness of 3 to 35 μm.

34. The metallized polyimide film of claim 23, wherein said roughening treated surface of said inorganic filler-containing polyimide film layer has a surface roughness of 100 to 1500 nm.

35. The metallized polyimide film of claim 23, wherein said conductive layer is a copper plating layer.

36. The metallized polyimide film of claim 23, wherein said roughening treated surface of said inorganic filler-containing polyimide film layer is obtained by a treatment with an alkaline permanganate solution.

37. The metallized polyimide film of claim 36, wherein said alkaline permanganate solution comprises at least one member selected from the group consisting of potassium permanganate, sodium permanganate, and mixtures thereof.

38. The metallized polyimide film of claim 23, wherein said inorganic filler-containing polyimide film further comprises one or more kinds of heat resistant resins selected from the group consisting of polyamide, polyamideimide, polyetheretherketone, polyetherimide, polybenzoxazole, polybenzoimidazole, and mixtures thereof in a proportion of not more than 30 parts by weight relative to 100 parts by weight of polyimide.

39. The metallized polyimide film of claim 38, wherein said heat resistant resin has a phenolic hydroxyl group in a molecular skeleton.
